(19) United States
(12) Patent Application Publication
(10) Pub. No.: US 2004/0125616 A1
(43) Pub. Date: Jul. 1, 2004

(54) Method and apparatus for controlling a power supply in an electronic machine using a host

(75) Inventors: Kyung-Chool Choi, Gyeonggi-do (KR); Han-Chung Ryu, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/617,253

(22) Filed: Jul. 11, 2003

(30) Foreign Application Priority Data
Jul. 23, 2002 (KR) 2002-43276

(51) Int. Cl. H02M 3/335

(52) U.S. Cl. 363/16

(57) ABSTRACT

A method and apparatus for controlling a power supply, having a power switching unit, in an electronic machine using a host connected to the electronic machine. Received alternating current (AC) power is transmitted to the power switching unit and simultaneously transformed into direct current (DC) power. Next, it is determined whether the host requests provision of the DC power to the electronic machine. Then, the power switching unit is driven using the AC power when it is determined that provision of the DC power to the electronic machine is requested. Thus, even when a power switching unit is not supplied with power immediately after interruption of power from an AC power supply source, charges stored in an electrolytic capacitor are not discharged so that incorrect operation of the electronic machine is prevented.

### CROSS-REFERENCE TO RELATED APPLICATIONS

This application claims priority from Korean Patent Application No. 2002-43276, filed on Jul. 23, 2002, in the Korean Intellectual Property Office, the disclosure of which is incorporated herein in its entirety by reference.

### BACKGROUND OF THE INVENTION

1. Field of the Invention

The present invention relates to the control of a power supply in an electronic machine by using a host, and, more particularly, to a method and apparatus for preventing the generation of errors in an electronic machine by controlling supply of power using a host, such as a host computer, for example.

2. Description of the Related Art

A general electronic machine connected to a host operates intermittently in response to a user's instruction. However, even when the electronic machine is not used, the power is frequently left on. For example, a printer connected to a computer prints material that a user requests to be printed when the power is switched on. Even when the printer does not perform a printing operation, the power is still on. Also, even when the printer is switched off, a part of the printer system or the entire system is continuously supplied with power. Hence, power is wasted when an electronic machine does not operate, and, accordingly, a host requires an apparatus for controlling the power supply of the electronic machine. A power supply including a power switching unit is referred to as a switching mode power supply (SMPS).

In an SMPS, alternating current (AC) power is rectified and smoothed using a diode and an electrolytic capacitor to turn the AC into a signal having a specified voltage, which is then applied to a transformer. A smoothing circuit connected to a secondary side of the transformer smoothes the transformed signal to obtain desired DC power used in electronic machines.

In an SMPS including a power switching unit whose supply of power is controlled by a host, if the power is turned off (i.e., a no-power state) due to the pulling-out of a power cord or an abrupt electricity failure while power is being supplied to an electronic machine, charges are discharged from the electrolytic capacitor through a resistor connected to the electrolytic capacitor for several seconds or several minutes. However, if an electronic machine attempts to draw power (e.g., if a computer transmits print data to a printer or a user turns on a selection switch used to supply power) from the power switching unit when it is in a no-power state before charges are completely discharged from the electrolytic capacitor, the SMPS instantaneously recognizes the charges being discharged from the electrolytic capacitor as power that is output from a power source, rectified, and smoothed, and consequently tries to supply DC power to the electronic machine. However, because no rectified and smoothed power has been supplied, the electronic machine operates incorrectly.

### SUMMARY OF THE INVENTION

It is an aspect of the present invention to provide a method of controlling the power supply in an electronic machine using a host, by which incorrect operation of the electronic machine is prevented, even when the AC power is not being supplied to the power switching unit.

It is another aspect of the present invention to provide an apparatus that performs the above method.

Additional aspects and/or advantages of the invention will be set forth in part in the description that follows and, in part, will be obvious from the description, or may be learned by practice of the invention.

To achieve the above and/or other aspects of the present invention, there is provided a method of controlling a power supply, having a power switching unit, in an electronic machine using a host connected to the electronic machine, the method including transmitting received alternating current (AC) power to the power switching unit and simultaneously transforming the AC power into direct current (DC) power; determining whether the host requests provision of the DC power to the electronic machine; and driving the power switching unit using the AC power when in response to determining that provision of the DC power to the electronic machine is requested.

To achieve the above and/or other aspects of the present invention, there is provided an apparatus for controlling a power supply, having a power switching unit, in an electronic machine using a host connected to the electronic machine, the apparatus including a power rectification unit transforming received alternating current (AC) power into direct current (DC) power and smoothing the DC power; a power switching unit, driven by the AC power, that is switched on or off to control provision of the DC power to the electronic machine when the host requests provision of DC power to the electronic machine; an AC power connection unit receiving the AC power and outputting the AC power to the power switching unit; and a power supply control unit controlling the operation of the power switching unit, regardless of whether power is supplied from the power supply of the electronic machine.

To achieve the above and/or other aspects according to the present invention, there is provided a circuit for controlling a power supply, having a power switching circuit, in an electronic machine using a host connected to the electronic machine, the circuit including a power rectification circuit transforming received alternating current (AC) power into direct current (DC) power and smoothing the DC power; a power switching circuit, driven by the AC power, that is switched on or off to control provision of the DC power to the electronic machine when the host requests provision of DC power to the electronic machine; an AC power connection circuit receiving the AC power and outputting the AC power to the power switching circuit; and a power supply control circuit controlling the operation of the power switching circuit, regardless of whether power is supplied from the power supply of the electronic machine.

To achieve the above and/or other aspects according to the present invention, there is provided a circuit for controlling a power supply, having a power switching circuit, in an electronic machine using a host connected to the electronic machine, the circuit including a power rectification circuit having an electrolytic capacitor, the power rectification circuit transforming received alternating current (AC) power into direct current (DC) power and smoothing the DC power, and the electrolytic capacitor having a discharge line that is open to prevent discharge of charges stored in the electrolytic capacitor; a power switching circuit, driven by the AC power, that is switched on or off to control provision of the DC power to the electronic machine when the host requests provision of DC power to the electronic machine; an AC power connection circuit receiving the AC power and outputting the AC power to the power switching circuit; and a power supply control circuit controlling the operation of the power switching circuit, regardless of whether power is supplied from the power supply of the electronic machine.

These, together with other aspects and/or advantages that will be subsequently apparent, reside in the details of construction and operation as more fully hereinafter described and claimed, reference being had to the accompanying drawings forming a part thereof, wherein like numerals refer to like parts throughout.

### BRIEF DESCRIPTION OF THE DRAWINGS

These and/or other aspects and advantages of the invention will become apparent and more readily appreciated from the following description of the preferred embodiments, taken in conjunction with the accompanying drawings, of which:

FIG. 1 is a flowchart illustrating a method of controlling a power supply in an electronic machine using a host, according to an embodiment of the present invention;

FIG. 2 is a block diagram of an apparatus that performs the method of FIG. 1, according to the embodiment of the present invention; and

FIG. 3 is a circuit diagram of a primary side of a power supply according to the embodiment of the present invention, which includes an alternating current (AC) power connection unit, a power rectification unit, and a power switching unit that are included in the apparatus of FIG. 2.

### DETAILED DESCRIPTION OF THE PREFERRED EMBODIMENTS

Hereinafter, embodiments of the present invention will be described in detail with reference to the attached drawings, wherein the like reference numerals refer to the like elements throughout. The present invention may, however, be embodied in many different forms and should not be construed as being limited to the embodiments set forth herein; rather, these embodiments are provided so that the present disclosure will be thorough and complete, and will fully convey the concept of the invention to those skilled in the art.

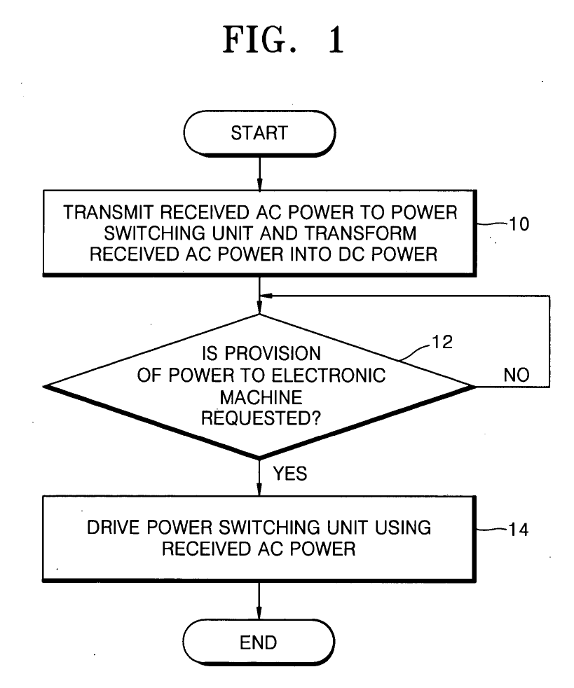

Referring to FIG. 1, a method of controlling the power supply in an electronic machine using a host, such as a host computer, includes both transforming received AC power into DC power and simultaneously transmitting the AC power to a power switching unit to drive the power switching unit.

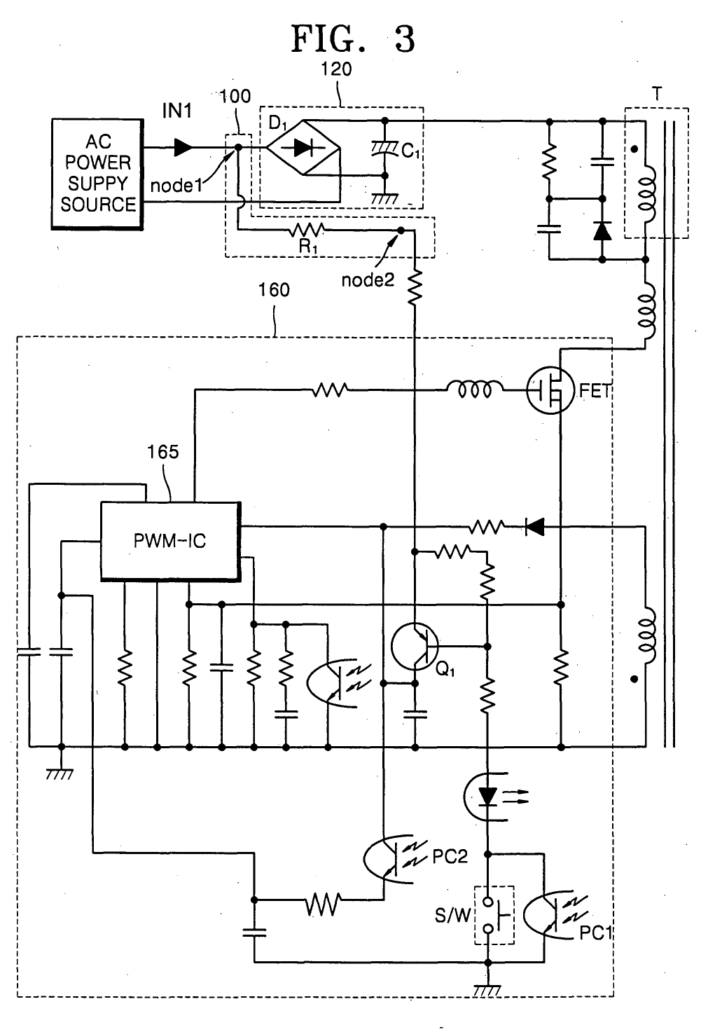

First, the received AC power is both transformed into DC power and transmitted to the power switching unit at operation 10. The AC power is commercial power, which is 110V or 220V. Before the AC power is used in an electronic machine, the AC power must be transformed into DC power. However, to drive a pulse width modulation-integrated circuit (PWM-IC) 165 (see FIG. 3) included in the power switching unit, the AC power does not need to be transformed into DC power. Hence, the received AC power is transmitted to the PWM-IC 165 of the power switching unit without being rectified.

While the AC power is being transmitted to the power switching unit, the AC power is transformed into DC power. To be more specific, the AC power is rectified by a diode and smoothed by an electrolytic capacitor, thereby turning the AC power into a signal having a specified voltage, which is applied to a transformer to yield DC power used in electronic machines.

Next, it is determined at operation 12 whether provision of DC power to the electronic machine is requested. For example, it is determined whether data for printing is received from a computer (host) or whether the state of the computer is changed from an on state to an off state. If it is determined at operation 12 that provision of DC power to the electronic machine is not requested, then the operation at 12 is repeated.

On the other hand, if it is determined at operation 12 that provision of DC power to the electronic machine is requested, the power switching unit is driven by the received AC power at operation 14. The PWM-IC 165 of the power switching unit is driven by the received AC power and transmits the rectified power obtained at operation 10 to a secondary side of the power supply.

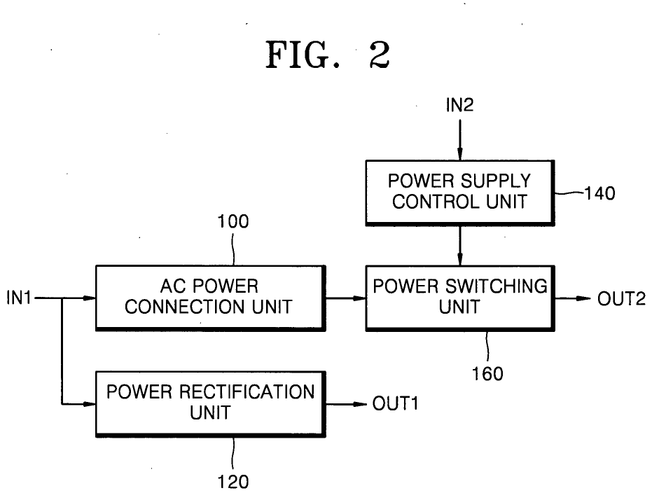

FIG. 2 is a block diagram of an apparatus that performs the method of FIG. 1, according to the embodiment of the present invention. The apparatus of FIG. 2 includes an AC power connection unit 100, a power rectification unit 120, a power supply control unit 140, and a power switching unit 160.

FIG. 3 is a circuit diagram of a primary side of a power supply including the AC power connection unit 100, the power rectification unit 120, and the power switching unit 160 of FIG. 2.

To transmit AC power to the power switching unit 160 and transform the AC power into DC power (FIG. 1, at operation 10), referring to FIGS. 2 and 3, the AC power connection unit 100 receives commercial AC power via an input terminal IN1 and outputs the received AC power to the power switching unit 160.

Referring to FIG. 3, the AC power connection unit 100, which includes first and second nodes node 1 and node 2 and a resistor R1, receives AC power from an AC power supply source via node 1 and transmits the AC power via the resistor R1 to node 2, which is connected to the power switching unit 160. Node 1 is located on a circuit line that receives the AC power, and node 2 is located on a circuit line connected to the power switching unit 160.

The power rectification unit 120 transforms the received AC power into a signal having a specified voltage, which is transmitted to a transformer T. Referring to FIG. 2, the power rectification unit 120 rectifies and smoothes the AC power received via the input terminal IN1 and transmits the resultant power to the transformer T.

Referring to FIG. 3, the power rectification unit 120 receives AC power from the AC power supply source and rectifies the AC power by transmitting forward current and blocking backward current using a diode D1. The power rectification unit 120 also removes ripple current (i.e., smoothes) from the rectified power using an electrolytic capacitor C1 and outputs smoothed and rectified power.

In contrast to the related art, the discharge line of the electrolytic capacitor C1 in the power rectification unit 120 is open. Accordingly, even when the power supply is turned off, charges stored in the electrolytic capacitor C1 to achieve power smoothing are not discharged. In the related art, the electrolytic capacitor C1 is connected to the power switching unit 160 to supply power to and drive the power switching unit 160. However, in the present invention, the electrolytic capacitor C1 is not connected to the power switching unit 160, so charges stored in the electrolytic capacitor C1 are not discharged even when the power supply is switched on. Therefore, incorrect operation of the electronic machine due to discharge of the conventional electrolytic capacitor C1 is prevented.

To determine whether provision of power to the electronic machine has been requested (FIG. 1, at operation 12), the power supply control unit 140 controls the operation of the power switching unit 160. To be more specific, the power supply control unit 140 receives a power supply control request signal via an input terminal IN2 from a host (not shown) connected to the electronic machine, and outputs a signal for controlling the power switching unit 160 connected to the primary side of the power supply.

In a case where a power supply of a printer (electronic machine) connected to a computer (host) is controlled, if the power supply control unit 140 receives print data from the computer, the power supply control unit 140 senses that power is to be supplied to the printer. Accordingly, the power supply control unit 140 transmits a signal for driving the power switching unit 160 to the power switching unit 160. If the power supply control unit 140 does not receive any print data from the computer within a predetermined period of time or if the state of the computer changes from an on state to an off state, the power supply control unit 140 senses that power provision to the printer is to be turned off. Accordingly, the power supply control unit 140 transmits a signal for turning off the power to operate the power switching unit 160 to the power switching unit 160.

The power supply control unit 140 drives the power switching unit 160 using power received from the host. Power (e.g., a voltage of +]5V) output from the host via a voltage bus line (not shown) is converted into a logic voltage (e.g., +3.3V or +2.5V) by a DC/DC converter (not shown), and the logic voltage is applied to the power supply control unit 140. Hence, the power supply control unit 140 can control the power switching unit 160 regardless of whether power is supplied from the power supply of the electronic machine.

To drive the power switching unit 160 (FIG. 1, at operation 14), the power switching unit 160 is driven by AC power and switched on or off to control the provision of DC power to the electronic machine. To be more specific, the power switching unit 160 receives a control signal associated with the power supply of the electronic machine from the power supply control unit 140, is driven by the AC power received from the AC power connection unit 100, and outputs the result of a decision regarding provision or non-provision of DC power rectified by the power rectification unit 120 via an output port OUT2.

Referring to FIG. 3, if the power switching unit 160 receives non-rectified AC power, but does not receive the signal for driving the power switching unit 160 from the power supply control unit 140, no operating power is applied to the PWM-IC 165 in the power switching unit 160. Hence, the rectified DC power is not supplied to the electronic machine.

If the computer transmits print data to the printer, and, accordingly, the power supply control unit 140 outputs the driving signal to the power switching unit 160, a photo transistor of a photo coupler PC1 in the power switching unit 160 operates to render the base of a PNP transistor Q1 in a low state. Because of the characteristics of the PNP transistor Q1, its collector and its emitter conduct such that the AC power received from the AC power connection unit 100 is used as operating power of the PWM-IC 165. Due to the operation of the PWM-IC 165, a field effect transistor (FET) is switched on to supply the power of the primary side of the power supply to the secondary side thereof. Hence, the printer is finally supplied with logic power (+5V) and drive power (+30V).

Also, instead of the control signal received from the power supply control unit 140, if a user inputs a switching signal representing power provision by pressing a selection switch S/W for power provision, the collector and the emitter of the PNP transistor Q1 conduct such that power is supplied to the printer by the operation of the PWM-IC 165.

On the other hand, if no print data are transmitted from the computer to the printer within a predetermined period of time after the printing operation of the printer is concluded, or if the power of the computer is turned off, the power switching unit 160 receives the control signal for stopping the operation of the power switching unit 160 from the power supply control unit 140. In response to the received signal, a photo coupler PC2 of the power switching unit 160 operates so that power for operating the PWM-IC 165 bypasses the PWM-IC 165 and is transmitted to a PWM enable terminal. Because the PWM-IC 165 does not receive power to operate, the FET is switched off so that the DC power is not transmitted to the secondary side of the power supply. Consequently, the DC power is not supplied to the printer.

Also, instead of the control signal being received from the power supply control unit 140, if a user turns off the power by pressing the selection switch S/W, the photo coupler PC2 operates such that power is not supplied to the printer.

In the related art, the PWM-IC 165 is driven by rectified and smoothed DC power. However, as shown in FIGS. 2 and 3, the PWM-IC 165 in the present invention is driven by AC power. Accordingly, even when the power switching unit 160 is driven by transmitting an electronic machine control signal from a host to the electronic machine that is not being supplied with power (e.g., when the host outputs print data to the printer) or by a user by pressing the selection switch S/W, incorrect operation of the electronic machine is prevented because the discharge line of the electrolytic capacitor has no discharge path.

In the method and apparatus according to the present invention for controlling a power supply in an electronic machine using a host, even when a power switching unit is not supplied with power immediately after interruption of power provision from an AC power supply source, charges stored in an electrolytic capacitor are not discharged so that incorrect operation of the electronic machine is prevented.

Although an embodiment of the present invention has been shown and described, it will be appreciated by those skilled in the art that changes may be made in this embodiment without departing from the principles and spirit of the invention, the scope of which is defined in the claims and their equivalents.

What is claimed is:

1. A method of controlling a power supply, having a power switching unit, in an electronic machine using a host connected to the electronic machine, the method comprising:
transmitting received alternating current (AC) power to the power switching unit and simultaneously transforming the AC power into direct current (DC) power;
determining whether the host requests provision of the DC power to the electronic machine; and
driving the power switching unit using the AC power when in response to determining that provision of the DC power to the electronic machine is requested.

2. An apparatus for controlling a power supply, having a power switching unit, in an electronic machine using a host connected to the electronic machine, the apparatus comprising:
a power rectification unit transforming received alternating current (AC) power into direct current (DC) power and smoothing the DC power;
a power switching unit, driven by the AC power, that is switched on or off to control provision of the DC power to the electronic machine when the host requests provision of DC power to the electronic machine;
an AC power connection unit receiving the AC power and outputting the AC power to the power switching unit; and
a power supply control unit controlling the operation of the power switching unit, regardless of whether power is supplied from the power supply of the electronic machine.

3. The apparatus of claim 2, wherein the power rectification unit comprises an electrolytic capacitor that smoothes rectified power and has a discharge line that is open to prevent discharge of charges stored in the electrolytic capacitor.

4. The apparatus of claim 2, wherein the power supply control unit is driven by power received from the host.

5. The apparatus of claim 2, wherein the AC power connection unit comprises:
a first node connected to an AC power supply source;
a second node connected to the power switching unit; and
a resistor between the first node and the second node,
wherein the AC power connection unit receives the AC power from the AC power supply source via the first node and transmits the AC power via the resistor to the second node.

6. The apparatus of claim 3, wherein the power rectification unit further comprises a diode receiving the AC power from the AC power supply source via the first node and rectifying the AC power, the electrolytic capacitor receiving the rectified power and outputting smoothed DC power to a transformer, without outputting the smoothed DC power to the power switching unit.

7. The apparatus of claim 4, wherein the power supply control unit transmits a signal to stop operation of the power switching unit when the power supply control unit does not receive a request from the host to provide DC power to the electronic machine within a predetermined period of time.

8. The apparatus of claim 4, wherein the power switching unit comprises a pulse width modulation-integrated circuit (PWM-IC), and when the power switching unit receives non-rectified AC power without receiving a signal from the power supply control unit to control the power switching unit, no power is provided to the PWM-IC and rectified DC power is not supplied to the electronic machine.

9. The method of claim 1, further comprising transmitting a signal to stop operation of the power switching unit when the host has not requested provision of the DC power to the electronic machine within a predetermined period of time.

10. A circuit for controlling a power supply, having a power switching circuit, in an electronic machine using a host connected to the electronic machine, the circuit comprising:
a power rectification circuit transforming received alternating current (AC) power into direct current (DC) power and smoothing the DC power;
a power switching circuit, driven by the AC power, that is switched on or off to control provision of the DC power to the electronic machine when the host requests provision of DC power to the electronic machine;
an AC power connection circuit receiving the AC power and outputting the AC power to the power switching circuit; and
a power supply control circuit controlling the operation of the power switching circuit, regardless of whether power is supplied from the power supply of the electronic machine.

11. The circuit of claim 10, wherein the power rectification circuit comprises an electrolytic capacitor that smoothes rectified power and has a discharge line that is open to prevent discharge of charges stored in the electrolytic capacitor.

12. The circuit of claim 11, wherein the power supply control circuit is driven by power received from the host.

13. The circuit of claim 10, wherein the AC power connection circuit comprises:
a first node connected to an AC power supply source;
a second node connected to the power switching circuit; and
a resistor between the first node and the second node,
wherein the AC power connection circuit receives the AC power from the AC power supply source via the first node and transmits the AC power via the resistor to the second node.

14. The circuit of claim 11, wherein the power rectification circuit further comprises a diode receiving the AC power from the AC power supply source via the first node and rectifying the AC power, the electrolytic capacitor receiving the rectified power and outputting smoothed DC power to a transformer, without outputting the smoothed DC power to the power switching circuit.

15. The circuit of claim 12, wherein the power supply control circuit transmits a signal to stop operation of the power switching circuit when the power supply control circuit does not receive a request from the host to provide DC power to the electronic machine within a predetermined period of time.

16. The circuit of claim 12, wherein the power switching circuit comprises a pulse width modulation-integrated circuit (PWM-IC) driven by the AC power, and when the power switching circuit receives non-rectified AC power without receiving a signal from the power supply control circuit to control the power switching circuit, no power is provided to the PWM-IC and rectified DC power is not supplied to the electronic machine.

17. The circuit of claim 16, wherein the discharge line of the electrolytic capacitor has no discharge path, preventing incorrect operation of the electronic machine.

18. A circuit for controlling a power supply, having a power switching circuit, in an electronic machine using a host connected to the electronic machine, the circuit comprising:
a power rectification circuit having an electrolytic capacitor, the power rectification circuit transforming received alternating current (AC) power into direct current (DC) power and smoothing the DC power, and the electrolytic capacitor having a discharge line that is open to prevent discharge of charges stored in the electrolytic capacitor;
a power switching circuit, driven by the AC power, that is switched on or off to control provision of the DC power to the electronic machine when the host requests provision of DC power to the electronic machine;
an AC power connection circuit receiving the AC power and outputting the AC power to the power switching circuit; and
a power supply control circuit controlling the operation of the power switching circuit, regardless of whether power is supplied from the power supply of the electronic machine.
